(19) United States
(12) Patent Application Publication
(10) Pub. No.: US 2006/0078672 A1
(43) Pub. Date: Apr. 13, 2006

(54) Coating of a cosmetic finish applied to a metallic surface

(76) Inventors: Nicholas Merz, San Francisco, CA (US); Richard Powell, Concord, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/234,860

(22) Filed: Sep. 23, 2005

Related U.S. Application Data
(60) Provisional application No. 60/612,890, filed on Sep. 24, 2004.

(51) Int. Cl. B05D 5/12; B05D 1/36

(52) U.S. Cl. 427/96.2; 427/402; 106/14.05

(57) ABSTRACT

Coating of a cosmetic finish applied to a metallic surface is provided to prevent the cosmetic finish from oxidizing and tarnishing. A clear adhesion promoting layer with a thickness of 5 to 10 microns is applied to the cosmetically finished metallic surface. A clear wear resistant layer with a thickness of 25 to 35 microns is subsequently applied over the clear adhesion promoting layer. In one variation, the metallic surface is first painted after which a portion of the painted surface is removed to expose the cosmetic finish. In another variation, the metallic surface has a raised portion representing e.g. a logo, emblem or other feature. In this case, the paint and a small amount of the metal substrate from the raised portion are removed to expose the cosmetic finish.

### CROSS-REFERENCE TO RELATED APPLICATIONS

This application is cross-referenced to and claims the benefit from U.S. Provisional Application 60/612,890 filed on Sep. 24, 2004, which is hereby incorporated by reference.

### FIELD OF THE INVENTION

This invention generally relates to coatings applied to metallic surfaces. In particular, the invention relates to coatings applied to a metallic surface of a portable electronic device to preserve a cosmetic finish of the portable electronic device.

### BACKGROUND OF THE INVENTION

Computers have long been known as ugly gray machines. Fortunately, over the last decade computer companies have put efforts into enhancing the appearance of computers. A beautiful and colorful example was the birth of the iMac by Apple Computers, Inc. In addition, computers are becoming increasingly smaller reaching the size of hand-held computers. Recent examples are the development of the Pocket PC or devices such as the OQO handheld computer.

These developments have placed an increased demand on the manufacturing process to deliver smart-looking devices with a good look-and-feel and cosmetic finish. For example, logos, emblems or other features are now an important cosmetic part of the computer casing. Unfortunately, with these developments, the production cost of these computers still needs to go down to remain competitive in the computer business.

One problem that needs to be addressed in this art relates to coating of a metallic computer case to preserve a cosmetic finish applied to the metallic surface. At present many coating techniques focus on the prevention of oxidation, such as plating, anodizing, alodining, chromating, passizating, phosphatizing, bonderizing, sputtering, physical vapor deposition (PVD), as well as painting with a variety of different paint chemistries (polyurethane, UV curing, etc.). Many of the existing techniques are applied in complex batch processing operations that can involve multiple chemical baths, multiple stages, extreme temperatures, high energy, specialized equipment, comparatively long cycle times, or otherwise complex processes. Additionally, many of these coatings, once applied, change the cosmetic appearance of the metallic surface; i.e. change the color, gloss, texture, shine, or other surfaces qualities of the underlying cosmetic finish. In the particular case of clear coatings many of the existing techniques have shortcomings, such as: (i) not providing sufficient adhesion to last over time, or (ii) not sufficiently preventing oxidation over time. Both shortcomings affect the cosmetic finish of a computer device or more generally of a portable electronic device. Accordingly, it would be considered an advance in the art to develop new ways to preserve cosmetic finishes applied to a metallic surface, especially in portable electronic devices.

### SUMMARY

The present invention provides new ways for preserving a cosmetic finish applied to a metallic surface, in particular that of a portable electronic device. The portable electronic device is made out of an aluminum alloy, a steel alloy, a titanium alloy, or a magnesium alloy, which are materials that easily oxidize and/or tarnish. A cosmetic finish is applied to the metallic surface, after which a clear adhesion promoting layer is applied. The clear adhesion promoting layers is preferably applied prior to any visible oxidation of the cosmetic finish. A clear wear resistant layer is subsequently applied over the clear adhesion promoting layer.

In one variation, the metallic surface is first painted after which a portion of the painted surface could be removed to expose the cosmetic finish. In another variation, the metallic surface has a raised portion representing e.g. a logo, emblem or other feature. In this case, the paint and a small amount of the metal substrate from the raised portion could be removed to expose the cosmetic finish.

The application of the clear adhesion layer includes mixing a primer with a catalyst reducer. The primer is based on 2-Methyl-1-propanol, Methyl Isobutyl Ketone and Methyl n-Amyl Ketone. The catalyst reducer is based on 2-Propanol, Methyl Ethyl Ketone and Phosphoric Acid. The primer is reduced with a diacetone alcohol to prepare a solution for pad printing of the clear adhesion promoting layer, or is reduced with a spray thinner to prepare a solution for spray coating of the clear adhesion promoting layer. The spray thinner is based on Toluene, 2-Propanol, 2-Methyl-1-propanol, and Methyl n-Amyl Ketone.

The application of clear wear resistant layer includes mixing a top coat with a catalyst. The top coat is based on Diisobutyl Ketone and n-Butyl Acetate. The catalyst is based on Light Aromatic Hydrocarbons, 1,3,5-Trimethylbenzene, 1,2,4-Trimethylbenzene, n-Butyl Acetate, Hexamethylene Diisocyanate, and Hexamethylene Diisocyanate Polymer. The top coat is reduced with a diacetone alcohol to prepare a solution for pad printing of the clear wear resistant layer, or reducing the top coat to prepare a solution for spray coating of the clear wear resistant layer. The reducer is based on Toluene, Isopropyl Acetate and n-Butyl Acetate.

Applying the present method to a portable electronic device results in having a portable electronic device with a cosmetic finish protected by a clear adhesion promoting layer with a thickness of 5 to 10 microns, and a clear wear resistant layer with a thickness of 25 to 35 microns.

### BRIEF DESCRIPTION OF THE FIGURES

The present invention together with its objectives and advantages will be understood by reading the following description in conjunction with the drawings, in which:

FIG. 1 shows a portable electronic device with a cosmetic finish according to the present invention; and

FIG. 2 shows a metallic substrate manufactured according to the present invention.

### DETAILED DESCRIPTION

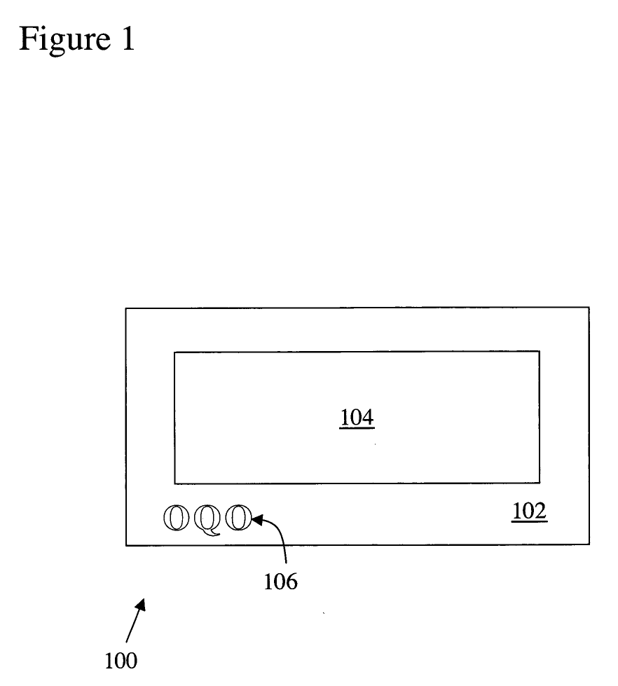

FIG. 1 shows a portable electronic device 100 with case 102, a display 104, and a logo portion 106. The portable electronic device 100 has a metallic surface that could be made out of an aluminum alloy, a steel alloy, a titanium alloy or a magnesium alloy. These alloys are strong and light, but can also easily be molded. Molding of case 102 is important to create logo portion 106, which is preferably raised from case 102. In the specific example of FIG. 1, the logo “OQO” is molded together with case 102. The advantage of molding the logo with the case is that there is no need to prepare a separate small part for the logo and attach that logo to the case.

The goal of the present invention is to apply a cosmetic finish to the metallic surface of logo 106 and/or other metallic surface parts of the case 102. Such a cosmetic finish could be applied by, for instance, brushing, blasting, sanding, graining, machining, polishing, grinding, buffing, peening, cutting or etching of the metallic surface. The cosmetic finish could also be applied by removing a layer from the metallic surface, patterning the metallic surface or casting, molding, forming or rolling of the metallic surface. A person of average skill in the art would readily appreciate that various other techniques could be used to apply the cosmetic finish, all of which are part of the scope of the invention.

If left untreated the metallic surface will loose its cosmetic value due to oxidation and tarnishing. Therefore, clear coating the cosmetically finished metallic surface is crucial. The preferred methods for clear coating according to the present invention is printing (pad printing) or spray painting. The clear coating process includes the application of two layers: (i) a clear adhesion promoting layer on the metallic surface with cosmetic finish, and (ii) a clear wear resistant layer on the clear adhesion promoting layer. The coating should provide: 1) strong adhesion when applied directly to finished substrate, 2) excellent long-term surface protection and wear resistance, and 3) simple and flexible production application.

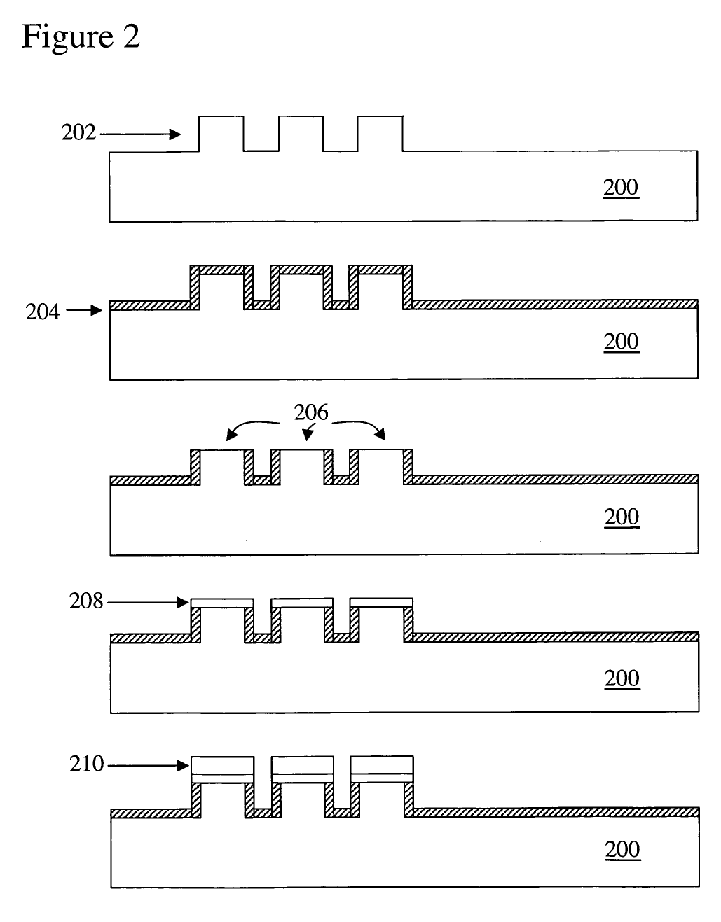

FIG. 2 shows a metallic substrate 200 with a raised portion 202 representing a logo, emblem or any other type of decorative feature. The three parts of raised portion 202 could resemble the side views of the logo “OQO”. In one variation of the invention, a layer of paint 204 could first be applied to the metallic surface of metallic substrate 200. A layer of paint could be used to provide a layer of protection and/or to affect the overall appearance of the metallic substrate. A cosmetic finish 206 is applied, e.g. to the raised portion 202, which will expose the raised portion as shown in FIG. 2. A clear adhesion promoting layer 208 with a thickness of 5 to 10 microns is applied to the metallic surface with cosmetic finish. On top of the clear adhesion promoting layer 208, a clear wear resistant layer 210 with a thickness of 25 to 35 microns is applied.

The following examples provide further details of the clear coating process, which results in the preservation of the cosmetic finish of the portable electronic device or computer case.

Clear Adhesion Promoting Layer

A fast drying, pretreatment type, 2 package acid catalyzed washcoat could be used to promote adhesion for a top clear coat. The washcoat, such as Raw Look Primer (F63VXC-20474-4365) available from the Sherwin-Williams Company (Cleveland Ohio, U.S.A.), could be used both for pad printing and for spray coating. The washcoat has excellent clarity, free of lead and chromates. The washcoat could be applied directly to the desired surface of a metallic substrate. A catalyst reducer, such as Wash Primer Catalyst Reducer (R7K44) available from the Sherwin-Williams Company, is mixed with the washcoat.

The washcoat (e.g., Raw Look Primer) and the catalyst reducer (e.g., Wash Primer Catalyst Reducer) are mixed in a ratio of 469 to 100 (e.g., 469 grams to 100 grams) by weight or 1280 to 279.4 (e.g., 640 ml to 139.7 ml) by volume before application. In the example of pad printing, the mixture of the washcoat and the catalyst reducer is then reduced 30%-50% with a Diacetone Alcohol (e.g., Diacetone Alcohol (R6K24) from the Sherwin-Williams Company). In the example of spraying, the mixture of the washcoat and the catalyst reducer can be reduced up to 150% with a spray thinner (e.g., Spray Thinner (R7XXC-20475) available from the Sherwin-Williams Company).

The washcoat (e.g., Raw Look Primer (F63VXC-20474) of the Sherwin-Williams Company) could include by weight: 64% of 2-Methyl-1-propanol, 17% of Methyl Isobutyl Ketone, and 5% Methyl n-Amyl Ketone. The catalyst reducer (e.g., Wash Primer Catalyst Reducer (R7K44) of the Sherwin-Williams Company) could include by weight: 50% of 2-Propanol, 44% of Methyl Ethyl Ketone, and 3% of Phosphoric Acid.

The spray thinner (e.g., Spray Thinner (R7XXC-20475) of the Sherwin-Williams Company) could include by weight: 44% of Toluene, 14% of 2-Propanol, 31% of 2-Methyl-1-propanol, and 11% of Methyl n-Amyl Ketone.

The Raw Look Primer (F63VXC-20474) promotes excellent adhesion for clear coats, is exceptionally fast for air dry, has excellent pad printing or spray capability, clear aesthetic design capability, excellent clarity and excellent flow capability, and is free of lead and chromates. Typically, the Raw Look Primer has a specific gravity of 0.83, 14% of solids in weight, 11% of solid in volume, and has a viscosity of 3100 centipoise.

Clear Wear Resistant Layer

Polane Falling Sand Clear (F63VXC-17924) of the Sherwin-Williams Company could be used as the clear wear resistant layer. The Polane Falling Sand Clear could include by weight: 15% of Diisobutyl Ketone and 30% of n-Butyl Acetate. Before application, a catalyst for the wear resistant coat, such as POLANE* HS Plus Exterior Catalyst (V66V55) of the Sherwin-Williams Company, is mixed with the clear wear resistant coat material (e.g., Polane Falling Sand Clear) a ratio of 231 to 50 by volume or 838 to 203 by weight.

The catalyst, such as POLANE* HS Plus Exterior Catalyst (V66V55) of the Sherwin-Williams Company, could include by weight: 1% of Light Aromatic Hydrocarbons, 1% of 1,3,5-Trimethylbenzene, 2% of 1,2,4-Trimethylbenzene, 5% of n-Butyl Acetate, 0.2% of Hexamethylene Diisocyanate (max.), and 90% of Hexamethylene Diisocyanate Polymer.

In the example of pad printing, the mixture of the clear wear resistant coat and the catalyst is reduced with a Diacetone Alcohol (e.g., Diacetone Alcohol (R6K24) from the Sherwin-Williams Company). In the example of spraying, the mixture of the clear wear resistant coat and the catalyst can be reduced (e.g., using POLANE* 66 Reducer (R7K84) of the Sherwin-Williams Company).

An example of a reducer for the wear resistant coat is e.g. POLANE* 66 Reducer (R7K84) of the Sherwin-Williams Company, and could include by weight: 20% Toluene, up to 36% of Isopropyl Acetate, and up to 45% of 123-86-4 n-Butyl Acetate. Polane Falling Sand

Clear has exceptional falling sand resistance (35 liters/mil avg. #16 silicon carbide) and rub resistance (900-1000 CD18900 Rub Resistance). Typically, the Falling Sand Clear has a specific gravity of 0.99, a viscosity of 1300 centipoise, 62.6% of Solids in Weight, 60° Gloss of over 90, and a pencil hardness of 2H.

Example of Coating Process

The clear coating process could distinguish the following method steps:
1. Applying the desired cosmetic finish to the metallic surface. The surface is treated within a 30-minutes window to prevent the oxidization of the cosmetic finish and therewith destroying the cosmetic appearance. In general, the surface is treated prior to any visible oxidation of the cosmetic finish.
2. Mixing an appropriate quantity of the Raw Look Primer, and using the appropriate thinner for either spray or pad printing. For example, the Raw Look Primer can be mixed with the Wash Primer Catalyst Reducer and reduced with the Diacetone Alcohol for pad printing or reduced with the Spray Thinner for spray.
3. Applying the Raw Look Primer to the metallic surface either by spray or pad printing. In one example, the primer is only air-dried or flash dried the primer, but not oven cured (before the application of the clear top coat). In one example, the clear adhesion promoting layer is dried for 5 minutes at 35 degrees Celsius (entry oven) and 5 minutes at 55 degrees Celsius (exit oven)).
4. Mixing an appropriate quantity of the Falling Sand Clear, using appropriate thinner for either spray or pad printing. For example, the Falling Sand Clear can be mixed with the POLANE* HS Plus Exterior Catalyst and reduced with the Diacetone Alcohol for pad printing or reduced with the POLANE* 66 Reducer for spray.
5. Applying the Falling Sand Clear to the target surface over the Raw Look Primer either by spray or by pad printing. In one example, the coatings are oven cured (e.g., after air dry or flash dry the Falling Sand Clear). In one example, the clear wear resistant layer is dried for 5 minutes at 35 degrees Celsius (entry oven) and 5 minutes at 40 degrees Celsius (exit oven)). The clear coats could then be baked and cured for 30 minutes at 65 degree Celsius in a convection oven.

The result is a tough anti-oxidant coating that preserves the look of the substrate underneath. A cure time of about 12 hours in a well-ventilated area at room temperature conditions (e.g., 25 degree Celsius) is preferred prior to quality control and packaging for shipment. The coated parts can continue to cure and release volatile compounds for up to one month after the final cure. Therefore, the packaging of the portable electronic device with the coatings of the present invention should preferably be breathable. For example, if the devices are individually wrapped in bags, bags could then be perforated with slits or holes to allow out-gassing. Open trays that allow airflow can also be used.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1. A method for preserving a cosmetic finish applied to a metallic surface of a portable electronic device, comprising:
(a) applying said cosmetic finish to said metallic surface of said portable electronic device;
(b) applying a clear adhesion promoting layer on said metallic surface with said cosmetic finish; and
(c) applying a clear wear resistant layer on said clear adhesion promoting layer,
wherein said clear adhesion promoting layer and said clear wear resistant layer preserve said cosmetic finish.

2. The method as set forth in claim 1, wherein said portable electronic device is made out of an aluminum alloy, a steel alloy, a titanium alloy, or a magnesium alloy.

3. The method as set forth in claim 1, wherein said clear adhesion promoting layer is applied within 30 minutes of the exposure of air to said cosmetic finish or prior to any visible oxidation of said cosmetic finish.

4. The method as set forth in claim 1, wherein said applying said cosmetic finish comprises the step of removing a layer from said metallic surface.

5. The method as set forth in claim 1, wherein said applying said cosmetic finish comprises brushing, blasting, sanding, graining, machining, polishing, grinding, buffing, peening, cutting or etching of said metallic surface.

6. The method as set forth in claim 1, wherein said applying said cosmetic finish comprises casting, forming or rolling of said metallic surface.

7. The method as set forth in claim 1, wherein said applying of said clear adhesion promoting layer or said clear wear resistant layer is accomplished by printing or spraying.

8. The method as set forth in claim 1, wherein said clear adhesion promoting layer has a thickness of 5 to 10 microns and said clear wear resistant layer has a thickness of 25 to 35 microns.

9. The method as set forth in claim 1, wherein said applying of said clear adhesion layer further comprises:
(i) mixing a primer with a catalyst reducer, wherein said primer comprises 2-Methyl-1-propanol, Methyl Isobutyl Ketone and Methyl n-Amyl Ketone, wherein said catalyst reducer comprises 2-Propanol, Methyl Ethyl Ketone and Phosphoric Acid; and
(ii) reducing said primer with a diacetone alcohol to prepare a solution for pad printing said clear adhesion promoting layer, or reducing said primer with a spray thinner to prepare a solution for spray coating said clear adhesion promoting layer, wherein said spray thinner comprises Toluene, 2-Propanol, 2-Methyl-1-propanol, and Methyl n-Amyl Ketone.

10. The method as set forth in claim 1, wherein said applying of said clear wear resistant layer further comprises:
(i) mixing a top coat with a catalyst, wherein said top coat comprises Diisobutyl Ketone and n-Butyl Acetate, wherein said catalyst comprises Light Aromatic Hydrocarbons, 1,3,5-Trimethylbenzene, 1,2,4-Trimethylbenzene, n-Butyl Acetate, Hexamethylene Diisocyanate, and Hexamethylene Diisocyanate Polymer; and
(ii) reducing said top coat with a diacetone alcohol to prepare a solution for pad printing said clear wear resistant layer, or reducing said top coat with a reducer to prepare a solution for spray coating the clear wear resistant layer, wherein said reducer comprises Toluene, Isopropyl Acetate and n-Butyl Acetate.

11. The method as set forth in claim 1, further comprises painting said metallic surface and removing a portion of said painted surface to expose said cosmetic finish.

12. The method as set forth in claim 1, wherein said metallic surface has a raised portion and further comprises painting said metallic surface and removing said paint from said raised portion to expose said cosmetic finish.

13. A portable electronic device, comprising:
(a) a metallic surface of said portable electronic device having a cosmetic finish, wherein said metallic surface comprises an aluminum alloy, a steel alloy, a titanium alloy or a magnesium alloy;
(b) a clear adhesion promoting layer over said metallic surface with said cosmetic finish, wherein said clear adhesion promoting layer has a thickness of 5 to 10 microns; and
(c) a clear wear resistant layer over said clear adhesion promoting layer, wherein said clear wear resistant layer has a thickness of 25 to 35 microns.

14. The portable electronic device as set forth in claim 13, wherein said clear adhesion promoting layer is cured from a mixture of a primer and a catalyst reducer, and wherein said primer comprises 2-Methyl-1-propanol, Methyl Isobutyl Ketone and Methyl n-Amyl Ketone, and wherein said catalyst reducer comprises 2-Propanol, Methyl Ethyl Ketone and Phosphoric Acid.

15. The portable electronic device as set forth in claim 13, wherein said clear wear resistant layer is cured from a mixture of a top coat and a catalyst, wherein said top coat comprises Diisobutyl Ketone and n-Butyl Acetate, and wherein said catalyst comprises Light Aromatic Hydrocarbons, 1,3,5-Trimethylbenzene, 1,2,4-Trimethylbenzene, n-Butyl Acetate, Hexamethylene Diisocyanate, and Hexamethylene Diisocyanate Polymer.

16. A material for prime coating a metallic surface having a cosmetic surface, comprising:
(a) a primer, wherein said primer comprises 2-Methyl-1-propanol, Methyl Isobutyl Ketone and Methyl n-Amyl Ketone; and
(b) a catalyst reducer mixed with said primer, wherein said catalyst reducer comprises 2-Propanol, Methyl Ethyl Ketone and Phosphoric Acid.

17. The material as set forth in claim 16, wherein the ratio by weight between said primer and said catalyst is substantially 469 to 100.

18. The material as set forth in claim 16, wherein the ratio by volume between said primer and said catalyst is substantially 1280 to 279.

19. The material as set forth in claim 16, further comprises a diacetone alcohol to reduce said mixture of said primer and said catalyst 30 to 35 percent for printing.

20. The material as set forth in claim 16, further comprises a thinner, wherein said thinner comprises Toluene, 2-Propanol, 2-Methyl-1-propanol, and Methyl n-Amyl Ketone, and wherein said thinner reduces said mixture of said primer and said catalyst up to 150 percent for spraying.
